(19) United States
(12) Patent Application Publication
(10) Pub. No.: US 2012/0013262 A1
(43) Pub. Date: Jan. 19, 2012

(54) IGNITION APPARATUS FOR PLASMA JET IGNITION PLUG AND IGNITION SYSTEM

(75) Inventors: Daisuke Nakano, Kiyosu-shi (JP); Yoshikuni Sato, Nagoya-shi (JP); Hiroyuki Kameda, Aichi-gun (JP); Naofumi Yamamura, Nagoya-shi (JP); Daisuke Kasahara, Toyoake-shi (JP)

(73) Assignee: NGK SPARK PLUG CO., LTD.

(21) Appl. No.: 13/176,988

(22) Filed: Jul. 6, 2011

(30) Foreign Application Priority Data
Jul. 14, 2010 (JP) JP 2010-159282

(51) Int. Cl. F02P 3/09

(52) U.S. Cl. 315/209 CD

(57) ABSTRACT

An ignition apparatus for an ignition plug which uses a positive polarity power supply, which can cause the ignition plug to generate spark discharge while using its center electrode as a negative electrode, and which can adjust the timing of supply of electric energy to the ignition plug and the timing of charging of capacitors. The ignition apparatus is adapted to cause the ignition plug to generate spark discharge while using its center electrode as a negative electrode, and includes a positive power supply, and energy supply units. Each energy supply unit includes a capacitor connected at one end to the power supply and connected at the other end to the ignition plug; a switching unit for charging; and a switching unit for energy supply.

### FIELD OF THE INVENTION

The present invention relates to an ignition apparatus for a plasma jet ignition plug which ignites an air-fuel mixture through formation of plasma, and to an ignition system which includes the ignition apparatus.

### BACKGROUND OF THE INVENTION

Conventionally, a combustion apparatus, such as an internal combustion engine, uses a spark plug for igniting an air-fuel mixture through spark discharge. In recent years, in order to meet demand for high output and low fuel consumption, a plasma jet ignition plug has been proposed, since the plasma jet ignition plug provides quick propagation of combustion and can more reliably ignite even a lean air-fuel mixture having a higher ignition-limit air-fuel ratio.

Generally, the plasma jet ignition plug includes a tubular insulator having an axial hole, a center electrode inserted into the axial hole in such a manner that a front end surface thereof is located internally of a front end surface of the insulator, a metallic shell disposed externally of the outer circumference of the insulator, and an annular ground electrode joined to a front end portion of the metallic shell. Also, the plasma jet ignition plug has a space (cavity) defined by the front end surface of the center electrode and a wall surface of the axial hole. The cavity communicates with an ambient atmosphere via a through hole formed in the ground electrode.

Additionally, such a plasma jet ignition plug ignites an air-fuel mixture as follows. First, voltage is applied between the center electrode and the ground electrode, thereby generating spark discharge therebetween and thus causing dielectric breakdown therebetween. In this condition, high-energy current is applied between the center electrode and the ground electrode for effecting transition of a discharge state, thereby generating plasma within the cavity. The generated plasma is jetted through an opening of the cavity, thereby igniting the air-fuel mixture.

Meanwhile, a known ignition apparatus for a plasma jet ignition plug (hereinafter may be simply referred to as an “ignition plug”) includes a circuit which supplies voltage for spark discharge, a capacitor which supplies electric energy for generation of plasma, and a power supply which is connected in parallel to the capacitor and charges the capacitor. Also, there has been proposed an ignition apparatus which has the above-described configuration and is designed such that, in order to improve ignition performance and erosion resistance of the electrodes, the center electrode is caused to serve as a negative electrode for generation of spark discharge and plasma. In such an ignition apparatus, a power supply which generates a negative voltage is used. See, for example, Japanese Patent Application Laid-Open (kokai) No. 2007-170371 (“Patent Document 1”). Notably, a known power supply for generating negative voltage includes step-up means for stepping up a voltage from a battery to thereby generate a high voltage of negative polarity, and monitoring means for checking generation of the negative voltage.

Also, in another ignition apparatus designed for improvement of ignition performance, a plurality of capacitors are provided, and timings at which electric energy is supplied from the capacitors to an ignition plug are shifted from each other by means of a coil, etc., whereby electric energy is supplied to the ignition plug in a plurality of steps. See, far example, Japanese Patent Application Laid-Open (kokai) No. 2009-97500 (“Patent Document 2”).

### SUMMARY OF THE INVENTION

### Problems to be Solved by the Invention

However, the ignition apparatus disclosed in Patent Document 2 uses a power supply which generates a voltage of positive polarity and is configured such that the center electrode of an ignition plug serves as a positive electrode for generation of spark discharge and plasma. Accordingly, the ignition apparatus disclosed in Patent Document 2 may cause deterioration of ignition performance and/or erosion resistance.

Furthermore, although the ignition apparatus disclosed in Patent Document 2 can adjust, to some degree, the timings at which electric energy is supplied to an ignition plug, it cannot supply electric energy from each capacitor at an arbitrary timing. Moreover, charging of each capacitor is performed when the isolation between the center electrode and the ground electrode is restored after supply of electric energy to the ignition plug, and the charging timing cannot be adjusted at all. Accordingly, it is impossible to adjust the generated plasma in accordance with the states of a combustion apparatus and/or the ignition plug.

Also, the ignition apparatus disclosed in Patent Document 1, which uses a power supply capable of generating negative voltage so as to cause spark discharge, etc., by using the center electrode as a negative electrode, has the following problem. Generation of high voltage of negative polarity is relatively difficult, and, in general, the monitoring means for checking generation of the negative voltage tends to become complex in configuration. Accordingly, production cost may increase, and the ignition apparatus may become complex, although improvement of ignition performance, etc., is expected.

The present invention has been conceived in view of the above circumstances, and an object of the invention is to provide an ignition apparatus for a plasma jet ignition plug which uses a positive polarity power supply, which can cause the plasma jet ignition plug to generate spark discharge while using its center electrode as a negative electrode, and which can arbitrarily adjust both the timing of supply of electric energy to the ignition plug and the timing of charging of capacitors. Another object of the present invention is to provide an ignition system including such an ignition apparatus.

### Means for Solving the Problems

Configurations suitable for achieving the above object will next be described in itemized form. If needed, actions and effects peculiar to the configurations will also be described.

Configuration 1: An ignition apparatus for a plasma jet ignition plug of the present configuration is an ignition apparatus for a plasma jet ignition plug which includes a center electrode, a ground electrode, and a cavity which surrounds at least a portion of a gap formed between the two electrodes to thereby form a discharge space, wherein spark discharge is generated at the gap through application of voltage between the electrodes, and plasma is jetted from the cavity through application of electric energy to the center electrode in synchronism with the spark discharge, the center electrode serving as a negative electrode for generation of the spark discharge. The ignition apparatus comprises a power supply which generates positive voltage; and energy supply unit for supplying electric energy to the plasma jet ignition plug. The energy supply unit includes a capacitor, one end of the capacitor being connected to the power supply, and the other end thereof being connected to the plasma jet ignition plug; switching unit for charging, one end of the switching unit for charging being connected to a line between the capacitor and the plasma jet ignition plug, the other end thereof being grounded, and the switching unit for charging permitting and stopping charging of electric energy from the power supply to the capacitor; and switching unit for energy supply, one end of the switching unit for energy supply being connected to a line between the capacitor and the power supply, the other end thereof being grounded, and the switching unit for energy supply permitting and stopping supply of electric energy from the capacitor to the plasma jet ignition plug.

According to the above-described configuration 1, the capacitor is provided in series between the power supply which generates positive voltage and the ignition plug. Therefore, in a state in which the capacitor is charged, the side of the capacitor connected to the power supply becomes positive, and the side of the capacitor connected to the ignition plug becomes negative. Accordingly, when electric energy is supplied from the capacitor to the ignition plug, current flows from the ignition plug to the capacitor (that is, the center electrode serves as a negative electrode for generation of plasma). Thus, the ignition plug generates both spark discharge and plasma while using the center electrode as a negative electrode. Therefore, ignition performance and the erosion resistance of the electrodes can be enhanced.

Also, since the power supply is one which generates positive voltage, production cost can be reduced, and it is possible to more reliably prevent the apparatus from becoming complex.

Furthermore, the energy supply unit includes switching unit for energy supply and switching unit for charging. When the switching unit for energy supply is turned on and the switching unit for charging is turned off, electric energy can be supplied from the capacitor to the ignition plug. When the switching unit for energy supply is turned off and the switching unit for charging is turned on, electric energy can be charged from the power supply into capacitor. That is, the timing of supply of electric energy to the ignition plug and the timing of charging of the capacitor can be arbitrarily adjusted by changing the timings of ON/OFF switching of the two switching unit. By virtue of such a configuration, generated plasma can be adjusted in accordance with the states of a combustion apparatus and the ignition plug.

Configuration 2: An ignition apparatus for a plasma jet ignition plug of the present configuration is characterized in that, in the above configuration 1, a plurality of the energy supply unit are provided, and each energy supply unit is connected in parallel between the power supply and the plasma jet ignition plug.

According to the above-described configuration 2, electric energy can be supplied from the capacitors to the ignition plug in a superimposed manner, and electric energy can be supplied to the ignition plug a great number of times during a single spark discharge. That is, the supply timing, the supply amount, etc. of electric energy can be adjusted more finely, whereby plasma suitable for the states of the combustion apparatus and the ignition plug can be generated more readily.

Configuration 3: An ignition system of the present configuration comprises:
an ignition apparatus for a plasma jet ignition plug according to Configuration 2; and
control unit for controlling the switching unit for charging and the switching unit for energy supply,
wherein the control unit controls the switching unit for energy supply such that electric energy is supplied from the plurality of energy supply unit to the plasma jet ignition plug during a single spark discharge.

According to the above-described configuration 3, electric energy can be supplied to the ignition plug a plurality of times during a single spark discharge. Accordingly, by means of jetting flame a plurality of times during a single spark discharge, it is possible to secure the opportunity of ignition a plurality of times. Further, by increasing of electric energy supplied to plasma, it is possible to strengthen flame (increase the peak energy of plasma discharge current). As a result, ignition performance can be enhanced.

Configuration 4: An ignition system of the present configuration is characterized in that, in the above configuration 3, the control unit controls the switching unit for energy supply of the plurality of energy supply unit such that the capacitors of the plurality of energy supply unit sequentially supply electric energy during a single spark discharge, whereby electric energy is supplied to the plasma jet ignition plug a plurality of times during the single spark discharge.

As in the above-described configuration 4, the capacitors of the plurality of energy supply unit may sequentially supply electric energy during a single spark discharge. In this case as well, an action and an effect similar to those achieved by the above-described configuration 3 can be achieved. Furthermore, since a capacitor(s), other than the capacitor supplying electric energy, can have a time for charging, the plurality of capacitors can supply electric energy sequentially, whereby electric energy can be continuously supplied to the ignition plug.

Notably, the timing of electric energy supply and the timing of charging may be those as described in Configurations 5 to 7, which will be described next.

Configuration 5: An ignition system of the present configuration is characterized in that, in the above configuration 3 or 4, the control unit controls the switching unit for energy supply of the plurality of energy supply unit such that, during a period during which at least one capacitor supplies electric energy, supply of electric energy to the plasma jet ignition plug from a capacitor(s), other than the capacitor supplying electric energy, is started.

According to the above-described configuration 5, electric energy is continuously supplied to the ignition plug. Accordingly, it is possible to maintain flame over a longer period of time or further strengthen the flame. As a result, ignition performance can be enhanced further.

Configuration 6: An ignition system of the present configuration is characterized in that, in the above configuration 5, the control unit controls the switching unit for energy supply of the plurality of energy supply unit such that, during a period during which at least one capacitor supplies electric energy, supply of electric energy to the plasma jet ignition plug from a capacitor(s), other than the capacitor supplying electric energy is started, after plasma discharge current generated as a result of supply of the electric energy from the at least one capacitor reaches its peak.

According to the above-described configuration 6, electric energy is supplied from a capacitor(s), other than the capacitor supplying electric energy, after plasma discharge current generated as a result of supply of the electric energy from the at least one capacitor reaches its peak. Accordingly, the jetting time of flame can be prolonged, whereby ignition performance can be enhanced further.

Configuration 7: An ignition system of the present configuration is characterized in that, in any one of the above configurations 3 to 6, the control unit controls the switching unit for energy supply of the plurality of energy supply unit such that respective timings at which electric energy is supplied from at least two capacitors to the plasma jet ignition plug coincide with each other.

Since a plasma jet ignition plug is designed such that its cavity opens toward a combustion chamber, foreign substances, such as carbon and fuel, are apt to adhere to the wall surface of the cavity. If foreign substances adhere to the wall surface of the cavity and accumulate there, the foreign substances may hinder generation of spark discharge and plasma.

In contrast, according to the above-described configuration 7, since the respective timings at which electric energy is supplied from at least two capacitors to the ignition plug coincide with each other, the peak energy of plasma can be increased, whereby flame can be jetted more vigorously. Accordingly, in the case where a foreign substance is considered to adhere to the wall surface of the cavity (e.g., in the case where the insulation resistance between the center electrode and the ground electrode has decreased), such a foreign substance can be removed from the cavity more reliably, and spark discharge and plasma can be generated over a longer period of time.

Furthermore, according to the above-described configuration 7, since ignition takes place at a position closer to the center of a combustion chamber, ignition performance can be enhanced further.

Configuration 8: An ignition system of the present configuration is characterized in that, in any one of the above configurations 3 to 7, the control unit controls the switching unit for charging and the switching unit for energy supply of the plurality of energy supply unit such that, in synchronism with a timing at which at least one capacitor supplies electric energy, electric energy is charged into at least one capacitor, other than the capacitor supplying electric energy.

According to the above-described configuration 8, in synchronism with a timing at which at least one capacitor supplies electric energy, electric energy is charged into at least one capacitor, other than the capacitor supplying electric energy. Accordingly, without provision of a large number of energy supply unit, it becomes possible to supply electric energy from a single capacitor a plurality of times during a single spark discharge, whereby plasma of various forms can be generated more easily.

### BRIEF DESCRIPTION OF THE DRAWINGS

FIG. 1 is a block diagram schematically showing the configuration of an ignition system.

FIG. 2 is a time chart showing the timing of supply of electric energy, the timing of charging of capacitors, etc. in a first case.

FIG. 3 is a time chart showing the timing of supply of electric energy, the timing of charging of the capacitors, etc. in a second case.

FIG. 4 is a time chart showing the timing of supply of electric energy, the timing of charging of the capacitors, etc. in a third case.

FIG. 5 is a time chart showing the timing of supply of electric energy, the timing of charging of the capacitors, etc. in a fourth case.

FIG. 6 is a partially cutaway front view showing the configuration of an ignition plug.

### DETAILED DESCRIPTION OF PREFERRED EMBODIMENTS

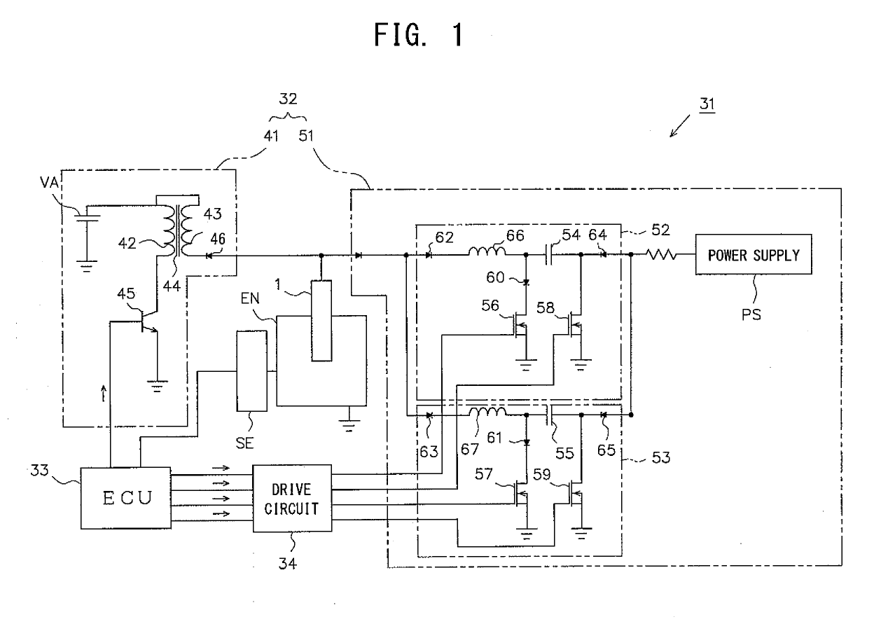

An embodiment of the present invention will next be described with reference to the drawings. FIG. 1 is a block diagram schematically showing the configuration of an ignition system 31 including an ignition apparatus 32 for a plasma jet ignition plug (hereinafter, referred to as the “ignition plug”) 1; and an electronic control unit (ECU) 33 of a vehicle, which serves as control unit for controlling the ignition apparatus 32.

First, the structure of the ignition plug 1, which is controlled by the ignition system 31, will be described briefly before description of the ignition system 31.

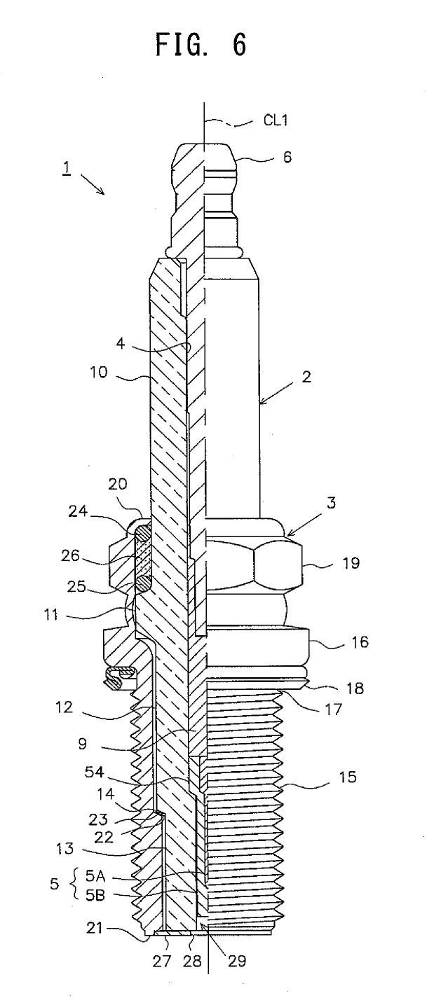

FIG. 6 is a partially cutaway front view showing the ignition plug 1. In FIG. 6, the direction of an axis CL1 of the ignition plug 1 is referred to as the vertical direction. In the following description, the lower side of the spark plug 1 in FIG. 6 is referred to as the front side of the spark plug 1, and the upper side as the rear side.

The ignition plug 1 includes a tubular insulator 2 and a tubular metallic shell 3, which holds the insulator 2 therein.

The insulator 2 is formed from alumina or the like by firing, as well known in the art. The insulator 2, as viewed externally, includes a rear trunk portion 10 formed on the rear side; a large-diameter portion 11, which is located frontward of the rear trunk portion 10 and projects radially outward; an intermediate trunk portion 12, which is located frontward of the large-diameter portion 11 and is smaller in diameter than the large-diameter portion 11; and a leg portion 13, which is located frontward of the intermediate trunk portion 12 and is smaller in diameter than the intermediate trunk portion 12. Additionally, the large-diameter portion 11, the intermediate trunk portion 12, and the leg portion 13 of the insulator 2 are accommodated within the metallic shell 3. A tapered, stepped portion 14 is formed at a connection portion between the intermediate trunk portion 12 and the leg portion 13. The insulator 2 is seated on the metallic shell 3 at the stepped portion 14.

Further, the insulator 2 has an axial hole 4 extending therethrough along the axis CL1. A center electrode 5 is fixedly inserted into a front end portion of the axial hole 4. The center electrode 5 includes an inner layer 5A made of, for example, copper or a copper alloy, which has excellent thermal conductivity, and an outer layer 5B made of a nickel (Ni) alloy (e.g. INCONEL (trademark) 600 or 601) which contains nickel as a main component. Further, the center electrode 5 assumes a rod like (circular columnar) shape as a whole. The front end surface of the center electrode 5 is located rearward of the front end surface of the insulator 2. Notably, a tip formed of a metallic material which is excellent in erosion resistance (e.g., Ir, Pt, W, or the like) may be provided at the front end of the center electrode 5.

Also, a terminal electrode 6 is fixedly inserted into a rear end portion of the axial hole 4 and projects from the rear end of the insulator 2.

A circular columnar glass seal layer 9 is disposed within the axial hole 4 between the center electrode 5 and the terminal electrode 6. The glass seal layer 9 electrically connects the center electrode 5 and the terminal electrode 6 together, and fixes the center electrode 5 and the terminal electrode 6 to the insulator 2.

Additionally, the metallic shell 3 is formed into a tubular shape from a low-carbon steel or a like metal. The metallic shell 3 has, on its outer circumferential surface, a threaded portion (externally threaded portion) 15 adapted to mount the ignition plug 1 into a mounting hole of a combustion apparatus (e.g., an internal combustion engine or a fuel cell reformer). Also, the metallic shell 3 has, on its outer circumferential surface, a seat portion 16 located rearward of the threaded portion 15. A ring-like gasket 18 is fitted to a screw neck 17 at the rear end of the threaded portion 15. Further, the metallic shell 3 has, near the rear end thereof, a tool engagement portion 19 having a hexagonal cross section and allowing a tool, such as a wrench, to be engaged therewith when the metallic shell 3 is to be mounted to the combustion apparatus. Also, the metallic shell 3 has a crimp portion 20 provided at a rear end portion thereof for retaining the insulator 2. Further, the metallic shell 3 has an annular engagement portion 21 formed externally at a front end portion thereof and projecting frontward with respect to the direction of the axis CL1. The ground electrode 27, which will be described later, is joined to the engagement portion 21.

Also, the metallic shell 3 has, on its inner circumferential surface, a tapered, stepped portion 22 adapted to allow the insulator 2 to be seated thereon. The insulator 2 is inserted frontward into the metallic shell 3 from the rear end of the metallic shell 3. In a state in which the stepped portion 14 of the insulator 2 butts against the stepped portion 22 of the metallic shell 3, a rear-end opening portion of the metallic shell 3 is crimped radially inward; i.e., the crimp portion 20 is formed, whereby the insulator 2 is fixed in place. An annular sheet packing 23 intervenes between the stepped portions 14 and 22 of the insulator 2 and the metallic shell 3, respectively. This retains gastightness of a combustion chamber and prevents outward leakage of fuel gas through a clearance between the leg portion 13 of the insulator 2 and the inner circumferential surface of the metallic shell 3.

Further, in order to ensure gastightness which is established by crimping, annular ring members 24 and 25 intervene between the metallic shell 3 and the insulator 2 in a region near the rear end of the metallic shell 3, and a space between the ring members 24 and 25 is filled with a powder of talc 26. That is, the metallic shell 3 holds the insulator 2 via the sheet packing 23, the ring members 24 and 25, and the talc 26.

The ground electrode 27 assumes the form of a disk and is formed from an Ir alloy which contains Ir as a main component. The ground electrode 27 is joined to a front end portion of the metallic shell 3 as follows: while the ground electrode 27 is engaged with the engagement portion 21 of the metallic shell 3, an outer circumferential portion of the ground electrode 27 is welded to the engagement portion 21.

In addition, the ground electrode 27 has a through hole 28 which extends through a central portion thereof in the thickness direction. The wall surface of the axial hole 4 and the front end surface of the center electrode 5 define a cavity 29. The cavity 29 communicates with an ambient atmosphere via the through hole 28.

High voltage is applied to the terminal electrode 6 of the above-described ignition plug 1 so as to generate spark discharge between the center electrode 5 and the ground electrode 27, thereby causing dielectric breakdown therebetween. In this condition, electric energy is applied between the center electrode 5 and the ground electrode 27 for effecting transition of a discharge state, thereby generating plasma within the cavity 29. Thus, flame is jetted from the through hole 28. Next, there will be described the configuration of the ignition system 31 including the ignition apparatus 32, which supplies high voltage and electric energy to the ignition plug 1.

As shown in FIG. 1, the ignition system 31 includes the ignition apparatus 32 and the ECU 33, and the ignition apparatus 32 includes discharge voltage supply unit 41 and plasma current supply unit 51.

The discharge voltage supply unit 41 supplies high voltage to the ignition plug 1 so as to generate spark discharge between the center electrode 5 and the ground electrode 27. The discharge voltage supply unit 41 includes a primary coil 42, a secondary coil 43, a core 44, and discharging switching unit 45.

One end of the primary coil 42, which is wound around the core 44, is connected to a power supply battery VA, and the other end thereof is connected to the discharging switching unit 45. One end of the secondary coil 43, which is also wound around the core 44, is connected to a line between the primary coil 42 and the battery VA, and the other end thereof is connected to the ignition plug 1 via a diode 46, which prevents reverse flow of current.

The discharging switching unit 45 is composed of a transistor, and permits and stops the supply of electric power from the battery VA to the primary coil 42 in accordance with an energization signal input from the ECU 33. When a high voltage is to be applied to the ignition plug 1, a current is caused to flow from the battery VA to the primary coil 42, whereby a magnetic field is formed around the core 44. In this state, the supply of the current from the battery VA to the primary coil 42 is stopped by the ECU 33 (which changes the level of the energization signal from an ON level to an OFF level). The stoppage of the current results in a change in the magnetic field around the core 44. Thus, the primary coil 42 generates a primary voltage through self-induction, and the secondary coil 43 generates a negative high voltage (several kV to several tens of kV). As a result of application of this negative high voltage to the ignition plug 1 (the terminal electrode 6), spark discharge is generated between the ground electrode 27 and the center electrode 5, which serves as a negative electrode.

The plasma current supply unit 51 includes a power supply PS for generating positive voltage, first energy supply unit 52, and second energy supply unit 53.

The first and second energy supply unit 52, 53 supply to the ignition plug 1 electric energy for generation of plasma. The first energy supply unit 52 includes a first capacitor 54, first switching unit for charging 56, and first switching unit for energy supply 58. The second energy supply unit 53 includes a second capacitor 55, second switching unit for charging 57, and second switching unit for energy supply 59.

First ends of the capacitors 54, 55 are connected to the power supply PS to be charged by the power supply PS, and second ends of the capacitors 54, 55 are connected to the ignition plug 1. The capacitors 54, 55 are each disposed in series between the power supply PS and the ignition plug 1. Therefore, when electricity is charged from the power supply PS into the capacitors 54, 55, the first end side of each capacitor 54, 55 becomes positive, and the second end side of each capacitor 54, 55 becomes negative. Accordingly, when the electric energy stored in each capacitor 54, 55 is supplied to the ignition plug 1, a current flows from the ignition plug 1 to the capacitor 54, 55, whereby plasma is generated. In this case, the center electrode 5 serves as a negative electrode.

The switching unit for charging 56 (57) permits and stops the supply of electric energy from the power supply PS to the capacitor 54 (55), and, in the present embodiment, is composed of a MOSFET. One end of the switching unit for charging 56 (57) is connected to a line between the capacitor 54 (55) and the ignition plug 1 via a diode 60 (61) for preventing reverse flow, and the other end thereof is grounded. Signals from the ECU 33 are input to the gate of the switching unit for charging 56 (57) via a drive circuit 34. When an ON signal is fed from the ECU 33 to the switching unit for charging 56 (57), the switching unit for charging 56 (57) turns on. When an OFF signal is fed from the ECU 33 to the switching unit for charging 56 (57), the switching unit for charging 56 (57) turns off. That is, the ON/OFF states of the switching unit for charging 56, 57 are controlled by the ECU 33.

The switching unit for energy supply 58 (59) permits and stops the supply of electric energy from the capacitor 54 (55) to the ignition plug 1, and, in the present embodiment, is composed of a MOSFET. One end of the switching unit for energy supply 58 (59) is connected to a line between the capacitor 54 (55) and the power supply PS, and the other end thereof is grounded. Signals from the ECU 33 are input to the gate of the switching unit for energy supply 58 (59) via the drive circuit 34. When an ON signal is fed from the ECU 33 to the switching unit for energy supply 58 (59), the switching unit for energy supply 58 (59) turns on. When an OFF signal is fed from the ECU 33 to the switching unit for energy supply 58 (59), the switching unit for energy supply 58 (59) turns off. That is, as in the case of the switching elements for charging 56, 57, the ON/OFF states of the switching unit for energy supply 58, 59 are controlled by the ECU 33.

Notably, when electric energy is to be charged from the power supply PS into the capacitor 54 (55), the ECU 33 turns the switching unit for charging 56 (57) on, and turns the switching unit for energy supply 58 (59) off. When the electric energy stored in the capacitor 54 (55) is to be supplied to the ignition plug 1, the ECU 33 turns the switching unit for charging 56 (57) off, and turns the switching unit for energy supply 58 (59) on.

Furthermore, the energy supply unit 52 (53) includes diodes 62, 64 (63, 65), and is configured to prevent reverse flow of current, which would otherwise occur at the time of charging of the capacitor 54 (55) or at the time of supply of electric energy to the ignition plug 1. Moreover, a coil 66 (67) is provided in the energy supply unit 52 (53) so as to prevent electric energy from being supplied to the ignition plug 1 all at once.

In addition, the ECU 33 is connected to various sensors, such as a water temperature sensor SE for acquiring information regarding the water temperature of an engine EN, a crank angle sensor for detecting the angle of a crank shaft, a knock sensor for detecting knocking of the engine EN, and an A/F sensor for air-fuel ratio measurement (notably, in FIG. 1, only the water temperature sensor SE is illustrated). The ECU 33 detects the combustion state of the engine EN and the state of the ignition plug 1 (e.g., whether or not a foreign substance adheres to the wall of the cavity 29) on the basis of information from the sensors and other information. On the basis of the combustion state of the engine EN and the state of the ignition plug 1, the ECU 33 determines the number of times of generation of plasma during a single spark discharge, a jetting time of flame, the peak energy of plasma (the jetting length of flame), etc. In order to adjust the number of times of generation of plasma, etc., in accordance with the determination, the ECU 33 controls the timing of supply of electric energy to the ignition plug 1 and the timing of charging of the capacitor 54, 55 by changing the ON/OFF timings of the switching unit for charging 56, 57 and the switching unit for energy supply 58, 59.

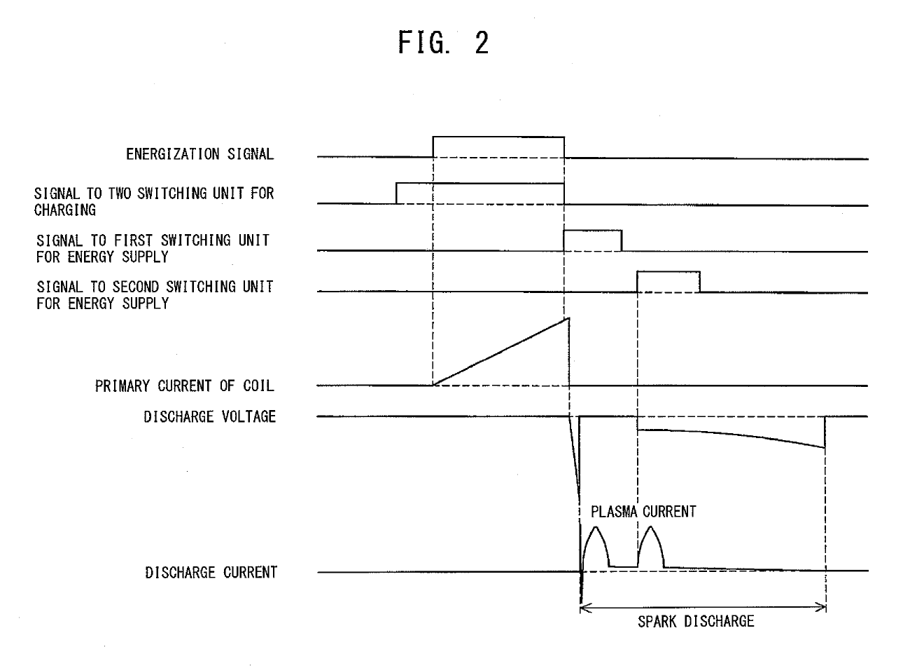

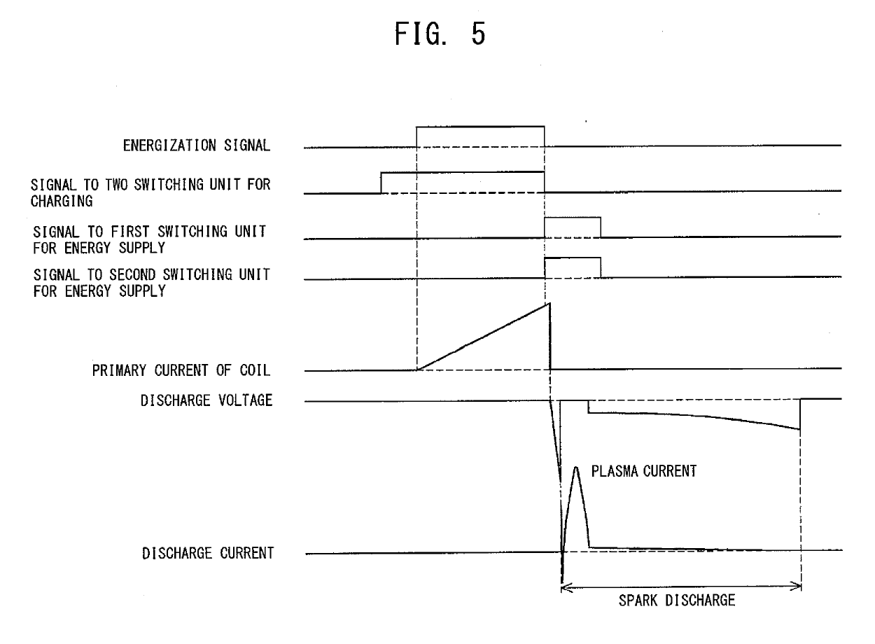

Next, with reference to FIGS. 2 to 5, the timing of supply of electric energy to the ignition plug 1 and the timing of charging of the capacitors 54, 55 will be described for first to fourth cases. Notably, the electric energy supply timings and the charging timings described below are mere examples, and may be changed in various manners in accordance with the information obtained from the sensors, the structure of the ignition plug 1, etc.

First Case

The case where the opportunity of ignition must be secured a plurality of times during a single spark discharge.

In the case where the ECU 33 determines on the basis of the information obtained from the sensors, etc., that the opportunity of ignition must be secured a plurality of times (that is, plasma must be generated a plurality of times during a single spark discharge), as shown in FIG. 2, before spark discharge, the ECU 33 first turns both the switching unit for charging 56 and 57 on, and turns both the switching unit for energy supply 58 and 59 off so as to charge the capacitors 54 and 55. Subsequently the ECU 33 turns both the switching unit for charging 56 and 57 off, and turns the first switching unit for energy supply 58 on in synchronism with spark discharge (timing at which the level of the energization signal is changed to the OFF level), to thereby supply the electric energy stored in the first capacitor 54 to the ignition plug 1. Furthermore, after the supply of electric energy from the first capacitor 54 to the ignition plug 1 is completed during the spark discharge, the ECU 33 turns the second switching unit for energy supply 59 on so as to supply electric energy from the second capacitor 55 to the ignition plug 1. By means of controlling the switching unit 56 to 59 in this manner, plasma can be generated a plurality of times during a single spark discharge, and the opportunity of ignition can be secured a plurality of times.

Second Case

The case where the opportunity of ignition must be secured a greater number of times during a single spark discharge.

In the above-described first case, the switching unit 56 to 59 are controlled such that the capacitors 54, 55 are charged before spark discharge. However, the capacitors 54, 55 may be charged during spark discharge. By means of charging the capacitors 54, 55 during spark discharge, it becomes possible to supply electric energy to the ignition plug 1 a plurality of times during a single spark discharge, the number of times being greater than the number of the energy supply unit 52 and 53.

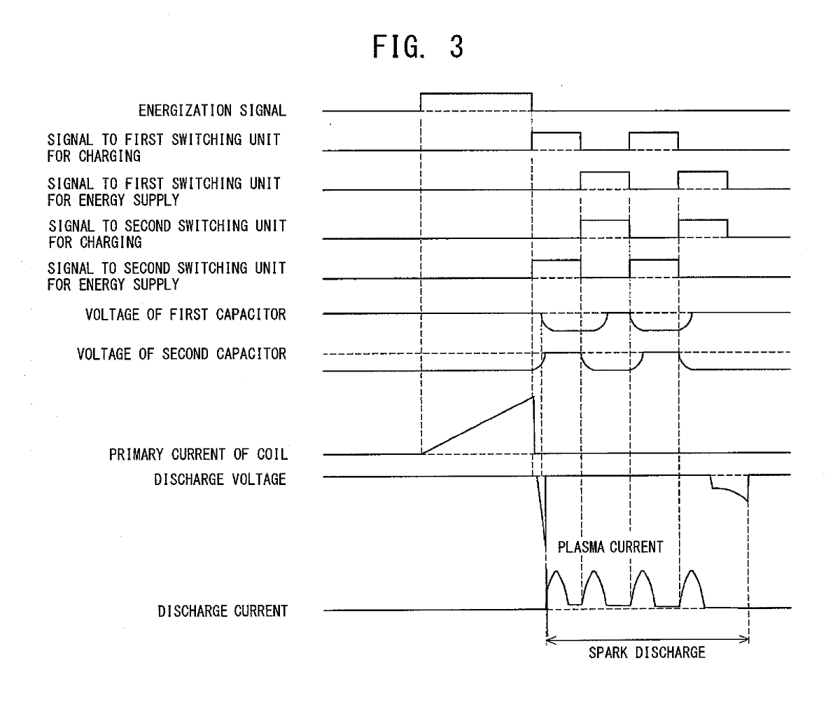

Accordingly, as shown in FIG. 3, in the first energy supply unit 52, the ECU 33 turns the first switching unit for charging 56 on, and turns the first switching unit for energy supply 58 off so as to charge the first capacitor 54. Meanwhile, in the second energy supply unit 53, the ECU 33 turns the second switching unit for charging 57 off, and turns the second switching unit for energy supply 59 on in synchronism with spark discharge, to thereby supply the electric energy stored in the second capacitor 55 to the ignition plug 1. After that time, through ON/OFF switching of the switching unit 56 to 59, supply of electric energy to the ignition plug 1 and charging of the capacitor 54, 55 are alternately performed in each energy supply unit 52, 53. As a result, through use of two energy supply unit 52 and 53, electric energy can be supplied to the ignition plug 1 a greater number of times during a single spark discharge. As a result, the opportunity of ignition can be secured a greater number of times.

Third Case

The case where flame must be jetted over a long period of time.

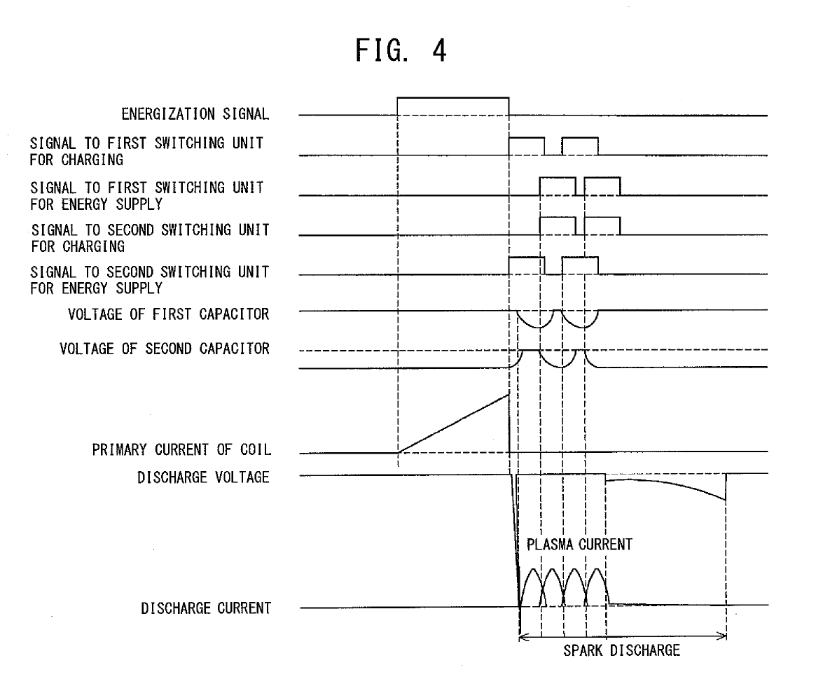

In the case where the ECU 33 determines on the basis of the information obtained from the sensors, etc., that the flame jetting period must be prolonged, the ECU 33 operates the switching unit 56 to 59 as shown in FIG. 4. Specifically, in the second energy supply unit 53, the ECU 33 turns the second switching unit for charging 59 off and turns the second switching unit for energy supply 57 on to thereby supply electric energy from the second capacitor 55 to the ignition plug 1. Meanwhile, in the first energy supply unit 52, in the period during which electric energy is supplied from the second capacitor 55 to the ignition plug 1, the ECU 33 turns the first switching unit for charging 56 off, and turns the first switching unit for energy supply 58 on. The changeover timings of the two switching unit 56 and 58 are slightly shifted from the changeover timings of the two switching unit 57 and 59 of the second energy supply unit 53. Therefore, the supply of electric energy from the first capacitor 54 to the ignition plug 1 is started at a certain point in the period during which electric energy is supplied from the second capacitor 55, the certain point being after the time point when a plasma discharge current produced as a result of supply of the electric energy has reached its peak.

When the supply of electric energy to the ignition plug 1 is completed in one energy supply unit 52 (53), while electric energy is being supplied from the other energy supply unit 53 (52) to the ignition plug 1, the switching unit for energy supply 58 (59) in the one energy supply unit 52 (53) is turned off, and the switching unit for charging 56 (57) in the one energy supply unit 52 (53) is turned on, whereby charging of the capacitor 54 (55) of the one energy supply unit 52 (53) is performed. After that time, while one energy supply unit 52 (53) is supplying electric energy, charging of the capacitor 55 (54) is performed and the supply of electric energy from the charged capacitor 55 (54) is started in the other energy supply unit 53 (52). With this operation, electric energy is continuously supplied to the ignition plug 1. As a result, flame is continuously jetted over a long period time, whereby ignition performance can be enhanced.

Fourth Case

The case where the peak energy of plasma must be increased.

In the case where the ECU 33 determines on the basis of the information obtained from the sensors, etc., that a foreign substance adheres to the wall of the cavity 29, in order to increase the peak energy of plasma (jetting length of flame), the ECU 33 turns the two switching unit for charging 56 and 57 off, and turns the two switching unit for energy supply 58 and 59 on at the same time so that the timing at which electric energy is supplied from the capacitor 54 to the ignition plug 1 coincides with the timing at which electric energy is supplied from the capacitor 55 to the ignition plug 1. With this operation, the peak energy of plasma can be increased, and the foreign substance adhering to the wall of the cavity 29 can be removed.

As having been described in detail, according to the present embodiment, the capacitors 54, 55 are each provided in series between the power supply PS, which generate positive voltage, and the ignition plug 1. Therefore, in a state in which the capacitor 54, 55 is charged, the side of the capacitor connected to the power supply PS becomes positive, and the side of the capacitor connected to the ignition plug 1 becomes negative. Accordingly, when electric energy is supplied from the capacitor 54, 55 to the ignition plug 1, current flows from the ignition plug 1 to the capacitor 54, 55 (that is, the center electrode 5 serves as a negative electrode for generation of plasma). Thus, the ignition plug 1 generates both spark discharge and plasma while using the center electrode 5 as a negative electrode. Therefore, ignition performance and the erosion resistance of the electrodes can be enhanced.

Also, since the power supply PS is one which generates positive voltage, production cost can be reduced, and it is possible to more reliably prevent the apparatus from becoming complex.

Furthermore, the energy supply unit 52 (53) includes the switching unit for energy supply 58 (59) and the switching unit for charging 56 (57), and can arbitrarily adjust the timing of supply of electric energy to the ignition plug 1 and the timing of charging of the capacitor 54 (55) by changing the timings of ON/OFF switching of the two switching unit 56, 58 (57, 59). By virtue of such a configuration, the supply of electric energy and the charging can be performed at proper timings in accordance with the states of the engine EN and the ignition plug 1. Thus, generation of plasma in the above-described various modes can be easily realized.

Moreover, since the energy supply unit 52, 53 is provided in plural number, as described above, electric energy can be supplied from the capacitors 54, 55 to the ignition plug 1 in a superimposed manner, and electric energy can be intermittently supplied to the ignition plug 1 a plurality of times during a single spark discharge. That is, according to the ignition system 31 of the present embodiment, through provision of the plurality of energy supply unit 52, 53, the supply timing, the supply amount, etc. of electric energy can be adjusted finely, whereby plasma suitable for the states of the engine EN and the ignition plug 1 can be generated more readily.

The present invention is not limited to the above-described embodiment, but may be embodied, for example, as follows. Of course, applications and modifications other than those exemplified below are also possible.

(a) In the above-described embodiment, two energy supply unit 52, 53 are provided. However, the number of the energy supply unit 52, 53 is not limited to two. Accordingly, a single energy supply unit may be provided between the power supply PS and the ignition plug 1, or three or more energy supply unit may be provided in parallel between the power supply PS and the ignition plug 1. Through provision of three or more energy supply unit, enhancement of ignition performance and increasing the peak energy of plasma can be realized more effectively.

(b) In the above-described embodiment, each of switching unit 56 to 59 is composed of a MOSFET. However, the switching unit for energy supply and/or the switching unit for charging may be composed of other semiconductor switches (e.g., transistors, etc.) or mechanical switches.

(c) In the above-described embodiment, the energy supply unit 52, 53 are controlled by the ECU 33. However, the embodiment may be modified such that the energy supply unit 52, 53 are controlled by a microcomputer which is provided separately.

### DESCRIPTION OF REFERENCE NUMERALS

1: ignition plug (plasma jet ignition plug);
5: center electrode;
27: ground electrode;
29: cavity;
31: ignition system;
32: ignition apparatus;
33: ECU (control unit);
52: first energy supply unit;
53: second energy supply unit;
54: first capacitor;
55: second capacitor;
56: first switching unit for charging;
57: second switching unit for charging;
58: first switching unit for energy supply; and
59: second switching unit for energy supply.

Having described the invention, the following is claimed:

1. An ignition apparatus for a plasma jet ignition plug which includes a center electrode, a ground electrode, and a cavity which surrounds at least a portion of a gap formed between the two electrodes to thereby form a discharge space, wherein spark discharge is generated at the gap through application of voltage between the electrodes, and plasma is jetted from the cavity through application of electric energy to the center electrode in response to the spark discharge, the center electrode serving as a negative electrode for generation of the spark discharge, the ignition apparatus comprising:
a power supply which generates positive voltage; and
energy supply unit for supplying electric energy to the plasma jet ignition plug, wherein the energy supply unit includes:
a capacitor, one end of the capacitor being connected to the power supply, and the other end thereof being connected to the plasma jet ignition plug;
switching unit for charging, one end of the switching unit for charging being connected to a line between the capacitor and the plasma jet ignition plug, the other end thereof being grounded, and the switching unit for charging permitting and stopping charging of electric energy from the power supply to the capacitor; and
switching unit for energy supply, one end of the switching unit for energy supply being connected to a line between the capacitor and the power supply, the other end thereof being grounded, and the switching unit for energy supply permitting and stopping supply of electric energy from the capacitor to the plasma jet ignition plug.

2. An ignition apparatus for a plasma jet ignition plug according to claim 1, wherein a plurality of the energy supply unit are provided, and each energy supply unit is connected in parallel between the power supply and the plasma jet ignition plug.

3. An ignition system comprising:
an ignition apparatus for a plasma jet ignition plug, the ignition apparatus comprising:
a power supply which generates positive voltage; and
energy supply unit for supplying electric energy to the plasma jet ignition plug, wherein the energy supply unit includes:
a capacitor, one end of the capacitor being connected to the power supply, and the other end thereof being connected to the plasma jet ignition plug;
switching unit for charging, one end of the switching unit for charging being connected to a line between the capacitor and the plasma jet ignition plug, the other end thereof being grounded, and the switching unit for charging permitting and stopping charging of electric energy from the power supply to the capacitor; and
switching unit for energy supply, one end of the switching unit for energy supply being connected to a line between the capacitor and the power supply, the other end thereof being grounded, and the switching unit for energy supply permitting and stopping supply of electric energy from the capacitor to the plasma jet ignition plug,
wherein a plurality of the energy supply unit are provided, and each energy supply unit is connected in parallel between the power supply and the plasma jet ignition plug; and
control unit for controlling the switching unit for charging and the switching unit for energy supply,
wherein the control unit controls the switching unit for energy supply such that electric energy is supplied from the plurality of energy supply unit to the plasma jet ignition plug during a single spark discharge.

4. An ignition system according to claim 3, wherein the control unit controls the switching unit for energy supply of the plurality of energy supply unit such that the capacitors of the plurality of energy supply unit sequentially supply electric energy during a single spark discharge, whereby electric energy is supplied to the plasma jet ignition plug a plurality of times during the single spark discharge.

5. An ignition system according to claim 3, wherein the control unit controls the switching unit for energy supply of the plurality of energy supply unit such that, during a period during which at least one capacitor supplies electric energy, supply of electric energy to the plasma jet ignition plug from a capacitor(s), other than the capacitor supplying electric energy, is started.

6. An ignition system according to claim 5, wherein the control unit controls the switching unit for energy supply of the plurality of energy supply unit such that, during a period during which at least one capacitor supplies electric energy, supply of electric energy to the plasma jet ignition plug from a capacitor(s), other than the capacitor supplying electric energy, is started, after plasma discharge current generated as a result of supply of the electric energy from the at least one capacitor reaches its peak.

7. An ignition system according to claim 3, wherein the control unit controls the switching unit for energy supply of the plurality of energy supply unit such that respective timings at which electric energy is supplied from at least two capacitors to the plasma jet ignition plug coincide with each other.

8. An ignition system according to claim 3, wherein the control unit controls the switching unit for charging and the switching unit for energy supply of the plurality of energy supply unit such that, in response to a timing at which at least one capacitor supplies electric energy, electric energy is charged into at least one capacitor, other than the capacitor supplying electric energy.
